(19) United States
(12) Patent Application Publication
(10) Pub. No.: US 2013/0057227 A1
(43) Pub. Date: Mar. 7, 2013

(54) METHOD AND APPARATUS FOR CONTROLLING A CONVERTER

(71) Applicants: Sergio AURTENETXEA, Gernika-Lumo (ES); Eneko OLEA, Durango (ES); Iker GARMENDIA, Ondarroa (ES); Ainhoa CARCAR, Pamplona (ES)

(72) Inventors: Sergio AURTENETXEA, Gernika-Lumo (ES); Eneko OLEA, Durango (ES); Iker GARMENDIA, Ondarroa (ES); Ainhoa CARCAR, Pamplona (ES)

(73) Assignee: INGETEAM TECHNOLOGY, S.A., Zamudio (Bizkaia) (ES)

(21) Appl. No.: 13/349,184

(22) Filed: Jan. 12, 2012

Related U.S. Application Data
(60) Provisional application No. 61/530,203, filed on Sep. 1, 2011.

(51) Int. Cl. H02P 9/48; H02H 7/06

(52) U.S. Cl. 322/28; 361/20

(57) ABSTRACT

An apparatus and method of controlling an electrical generating apparatus is provided. The apparatus includes an electrical generator configured to be connected to an electrical grid and a converter comprising an inverter connected to a rotor of the electrical generator. The apparatus also includes a shunt protection circuit connected to the inverter and the rotor of the electrical generator and a control unit configured to activate and deactivate the inverter and the shunt protection circuit. The control unit is configured to, in response to determining that an abnormal condition is occurring in the electrical generator or an electrical grid to which the electrical generator is connected, deactivate the inverter and activate the shunt protection circuit. Also, after it is determined that the abnormal condition has passed, the control unit is configured to activate the inverter before deactivating the shunt protection circuit.

### CROSS-REFERENCE TO RELATED PATENT APPLICATION

This application claims the benefit of U.S. Provisional Patent Application No. 61/530,203 filed on Sep. 1, 2011 in the U.S. Patent Trademark Office, the disclosure of which is incorporated herein in its entirety by reference.

### BACKGROUND OF THE INVENTION

1. Field of the Invention

Apparatuses and methods consistent with the present invention relate to a converter utilized in a wind turbine generator.

2. Description of the Related Art

The use of frequency converters in energy conversion systems is ever more common due to the advantages they bring when controlling electrical machines. Notably, they are used to convert mechanical energy into electrical energy in generators or to convert electrical energy into mechanical energy in motors. The main advantages of using converters are the improvement in energy efficiency and the ability to control the energy flow more accurately and dynamically.

Wind power generation is an example of one application where converters are used in systems converting mechanical energy. In wind power generation, the force of the wind is converted into electrical energy. In recent decades, wind power generation applications have evolved from using fixed speed generation applications having an efficiency of less than 90% to using variable speed generation applications, which are based on the use of converters. These variable speed generators have widened the wind speed range from which energy can be extracted, increased the accuracy and the dynamics of the power extracted and increased the performance of the assembly to efficiency values higher than 95%. Within the class of variable speed generation applications that use converters there are different topologies of which the doubly-fed topology is one of the most widely used because is provides a good balance between cost and the functional improvement. Due to the characteristics of the generator used in this topology, i.e., the doubly-fed asynchronous machine, it is sufficient to have a converter rated for a power of around only 33% of the total generator power in order to control 100% of the power generated by the generator. This is because only the power from the generator rotor flows through the converter, as the rest of the power is delivered directly from the generator stator to the grid.

In doubly-fed topologies the frequency converter connects to the generator rotor, which is accessible through slip rings that allow contact between the rotating part of the generator, the rotor, and the converter. The converter used in the doubly-fed topologies is usually composed of two parts. The first, known as the grid-side converter or rectifier, joins an alternating voltage (AC) stage that habitually corresponds to the electricity grid with a direct voltage (DC) stage. The second, known as the machine-side converter or inverter, joins the aforementioned direct voltage stage with the alternating voltage part of the generator rotor. This structure gives rise to an AC-DC-AC configuration known in technical literature as a back-to-back structure.

As previously mentioned, the rectifier of the converters used in doubly-fed topologies is usually connected to the electricity grid (power supply grid). This is usually a direction connection or a connection using a transformer that adapts the voltage levels to the values for which the converter has been designed. The doubly-fed topologies could also function by connecting the rectifier to a permanent-magnet generator coupled to the shaft of the wind turbine so that when it turns, the permanent-magnet generator generates a voltage in terminals that functions in a manner similar to the electricity grid.

Both the rectifier and the inverter are generally made up of static switches that are turned on and off by a central control unit that, using the measurements made by the transducers installed in the system, executes a control algorithm that defines the switching commands of the static switches. Thus the currents through the generator can be controlled, which allows the imposed power setpoints to be controlled. The most commonly used static switches are called IGBTs (Insulated Gate Bipolar Transistors). However, other types of switches can be used, such as GTOs (Gate Turn Off Thyristors) or IGCTs (Integrated Gate Commutated Thyristors).

The development of topologies such as the doubly-fed generators that provides a good relationship between cost and functionality, has been widely accepted in the market. Accordingly, in the last decade there has been a sharp increase in the installation of wind power generators connected to the electricity grid. As a result, a considerable percentage increase of energy from this renewable source is now injected into the energy distribution networks, a departure from a distributed generation structure based principally on thermal generation plants.

Faced with this new scenario the operators of the electricity grids have analyzed the impact that this new form of power generation has on the stability of the grids. As a consequence of these studies they have established regulatory frameworks defining connection standards that include certain requirements that must be met by installations with these characteristics.

The aforementioned grid connection standards define requirements such as the operational continuity that wind power generators must guarantee even in the event of grid disturbances such as voltage gaps. Voltage gaps are sudden drops in the voltage of the grid to which the generators and converters are connected. These disruptions cause situations of abnormal operation in which there are severe electrical disturbances that must be detected by the control units of the converters in order to take the measures necessary to guarantee functional continuity and operation within the safe functional range of the components that make up the converters.

To guarantee the functional continuity in the aforementioned situations of abnormal operation, the applications have electrical circuits specifically designed to protect the converter and damp the electrical disturbances that occur. In the case of doubly-fed topologies, shunt type protection circuits are often used. These are connected between the generator rotor and the inverter and are responsible for supporting the electrical transients that appear in the generator in the event of a situation of abnormal operation. For example, during a voltage gap on the grid the shunt type protection circuits prevent the converter from being adversely affected. This type of protection circuit is also known in technical documents as a crowbar circuit.

The protection or crowbar circuits used in doubly-fed topologies are designed to short-circuit the generator rotor directly, or alternatively, by using resistors. The protection circuits are connected when the central control unit detects an abnormal operation by controlling the variables measured in the system, so that when any of the variables are outside of the normal operating bounds, the protection circuit is connected. Connecting the protection circuit will cause the electrical disturbances that can appear in the generator to be absorbed by the protection circuit, so they do not affect the converter. At the same time, they also provide quicker damping of the electrical disturbances that can appear in the generator, allowing control of the generator current to be recovered more quickly, even before the fault condition or voltage gap on the grid has recovered. This means the current can be controlled in such a way that guarantees the requirements imposed by the aforementioned grid standards.

The severe current disturbances to which the aforementioned shunt protection circuits are subjected mean that they must be correctly dimensioned to be able to thermally support the energy that flows through them. Due to the inductive nature of the electrical machines to which the protection circuits are connected, in addition to the thermal dimensioning, it is necessary to provide these circuits with elements that help minimize the overvoltages that will appear in them when the off command is sent. That is, when the off command is sent, a large current that circulates through an inductive circuit is interrupted. The overvoltages that appear in the off phase of the protection circuits will be reflected directly in the generator rotor and can affect the insulation to ground and the generator bearings as a result of the leakage currents to ground that can be established by means of the parasitic capacitances. This is a very important consideration when trying to guarantee that the converter and generator function correctly and is an aspect of the invention described herein.

### SUMMARY OF THE INVENTION

Aspects of the invention relate to a control procedure for a converter used in applications that incorporate shunt protection circuits installed between the electrical machine and the converter (inverter), characterized by the fact that it contributes to the reduction in overvoltages that appear in the rotor windings of the electrical machine when the shunt protection circuit current is disconnected or interrupted following a prior connection of the shunt protection circuit to protect the converter from electrical disturbances generated in the machine due to abnormal operation.

The control procedure presented here may reduce the need to install specific circuits to reduce overvoltages or at least optimize their dimensions such that decoupling capacitor circuits (RC circuits) or varistors may be used.

The proposed control procedure may be implemented in existing systems without having to install new physical elements as it is an improvement that may be applied to the software that governs the converter. Therefore it may be applied by updating the control program used in the central control unit.

In addition, the proposed procedure optimizes of the operating conditions of the elements installed in the converter, increases the reliability of the system and minimizes maintenance work.

### BRIEF DESCRIPTION OF THE DRAWINGS

The above and other aspects and features of the various aspects of the present invention will become more apparent by describing in detail exemplary embodiments thereof with reference to the attached drawings in which:

FIG. 1 shows a single-wire electrical diagram of a wind power generation application based on a doubly-fed topology.

FIG. 2 shows the single-wire electrical diagram of the shunt protection circuit connected between the doubly-fed asynchronous generator rotor and the inverter.

FIG. 3 shows the generator and inverter current flows during the operation sequences that correspond to the normal operation of the application.

FIG. 4 shows the generator and inverter current flows during the operation sequences that correspond to abnormal operation of the application such as grid voltage gaps.

FIG. 5 shows the generator and inverter current flows, and a representation of the overvoltage value in the rotor terminals in the event of a sudden, non-optimized disconnection as proposed in this invention, of the shunt protection circuit.

FIG. 6 shows the current flow of the generator, inverter and shunt protection circuit, and a representation of the voltage value in the rotor terminals during the operation sequence for switching off of the shunt protection circuit in which an optimized cut-out takes place as proposed in this invention.

FIG. 7 shows a graphic representation of the electromechanical structure of a doubly-fed asynchronous generator.

FIG. 8 shows a graphic representation of the uncontrolled circulation of current that could be established if there are voltage peaks between the rotor windings and the earth, by means of the parasitic capacitances or other elements such as the bearing fastening the rotor to the stator.

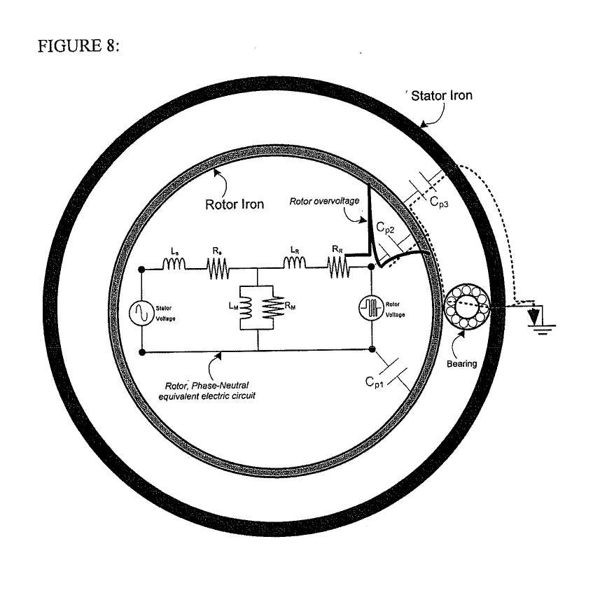

FIG. 9 is a diagram illustrating a system to which the embodiments of the present invention may be applied.

FIG. 10 is a flowchart showing a method in accord with an embodiment of the present invention.

### DETAILED DESCRIPTION OF THE INVENTION

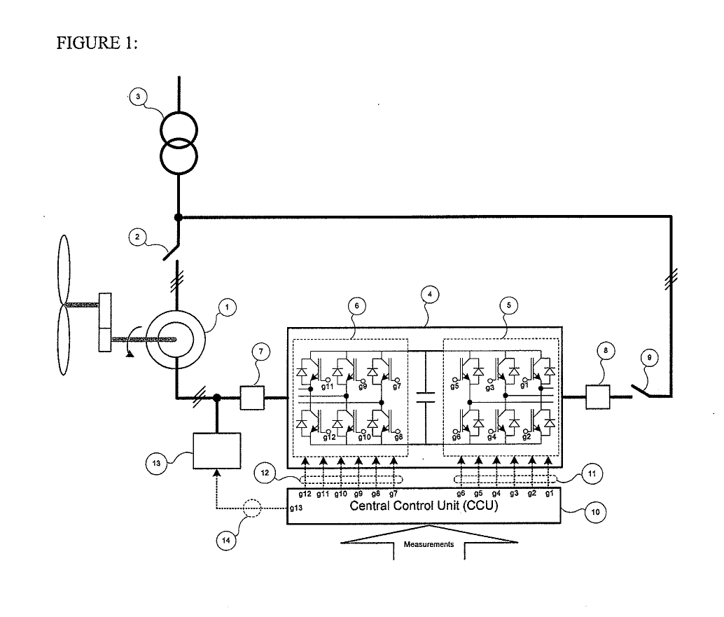

FIG. 1 shows a single-wire diagram of a wind power generation application based on a doubly-fed topology. The diagram shows the different parts that make up the application including the header transformer that will adapt the power supply, the wound rotor asynchronous generator, the frequency converter made up of the inverter and the rectifier, the shunt protection circuit, the grid connection filter, the generator connection filter, the main control unit, the generator-grid connection contact and the rectifier-grid connection contact.

As shown in FIG. 1, the doubly-fed asynchronous generator 1 includes a stator connected to the electricity grid through the stator coupling contact 2. The transformer 3 adapts the voltage levels of the electricity grid to which the generator 1 and frequency converter 4 are connected. The frequency converter 4 includes a grid side converter or rectifier 5 and a machine side converter or inverter 6. Also shown is a connection filter 7 disposed between the inverter 6 and the doubly-fed asynchronous generator rotor. Another connection filter 8 is disposed between the rectifier 5 and the connection contact 9 that connects the rectifier 5 to the electricity grid. Also shown is a central control unit 10 that executes the control algorithms using the measurements made on the system to determine the switching commands 11 of the static switches of the rectifier [g1 . . . g6], the switching commands 12 of the static switches of the inverter [g7 . . . g13] and the switching commands 14 of the static switches of the shunt protection circuit 13.

In an embodiment, the inverter 6 and the rectifier 5 are comprised of IGBT type static switches, governed for closing and opening by switching commands [g1 . . . g12] coming from the main control unit.

The filters 7, 8 for connecting to the grid and generator 1 may be made up of passive elements such as inductances, capacitors and/or resistors. The main function of the grid connection filter 8 is to filter the voltage and current waves to reduce the harmonic content of the energy sent to the grid. The main function of the generator connection filter 7 consists of softening the slopes of the voltage waves imposed by the inverter 6 on the rotor windings of the generator 1.

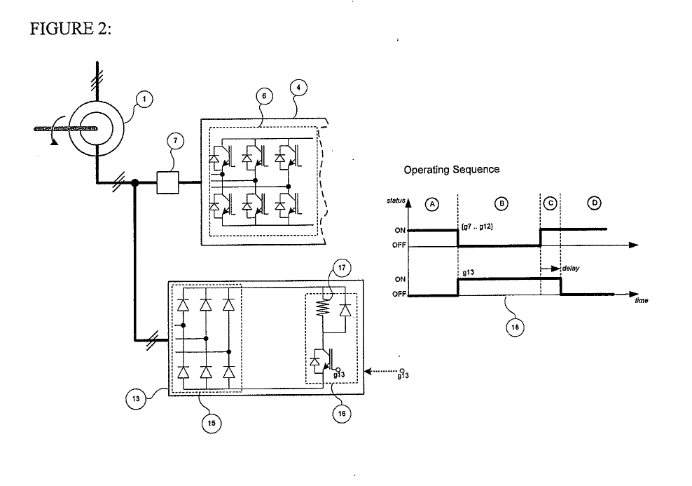

FIG. 2 shows a single-wire electrical diagram of the shunt protection circuit 13 of this embodiment. The different elements that make up the shunt protection circuit 13 include a rectifier jumper to diode (15) responsible for rectifying the alternating voltages of the rotor stages of the generator. Also includes is a resistor branch 16 that short-circuits the rectified voltage of the generator rotor by using a switch with on/off control. The resistor branch includes a resistor 17. The operation sequence of the shunt protection circuit 13 is controlled by a switching command 14 (g13).

In the embodiment as shown in FIG. 2, the shunt protection circuit 13 comprises a diode bridge 15 that rectifies the generator rotor voltages, where one or more resistor branches 16 will be connected at the output and controlled for opening and closing by IGBT type static switches. These static switches are governed by the central control unit 10 through specific switching commands 14 [g13]. The shunt protection circuit 13 may be composed of different branches with different resistance values meaning that different equivalent resistance values can be configured depending on whether the switches of each branch are connected or disconnected. In addition, the shunt protection circuit 13 may be configured to short-circuit the diode bridge 15 output that rectifies the rotor voltages directly, without using resistors.

The operation of the assembly is driven from the central control unit 10 that processes the measurements made by means of the transducers installed and executes the control algorithms programmed to control the power flow between the generator 1 and the grid. In most cases there are two different control algorithms, one for the rectifier 5 and another for the inverter 1. The rectifier control algorithm is responsible for controlling the current on the alternating voltage side that is connected to the electricity grid and the inverter algorithm is responsible for controlling the current of the electrical machine.

The end result of executing these algorithms is presented in the form of switching commands (g1 . . . g12) 11, 12 for the IGBTs installed in both the rectifier 5 and the inverter 6. These switching commands are calculated by means of modulation stages that use pulse width modulation mechanisms to synthesize using the direct voltage stage, the reference voltages that must be applied at the output of the inverter 6 and the rectifier 5 to control the current of each of them. The pulse width modulation mechanisms are widely in frequency converters and can vary between scalar and vector mechanisms. Scalar modulation mechanisms are based on the comparison of carrier-signals with modulating signals (for example PWM, Pulse Width Modulation). Vector mechanisms apply vectors or certain switching templates during specific times calculated previously in the aforementioned modulation stages (for example SVPWM, Space Vector Pulse Width Modulation).

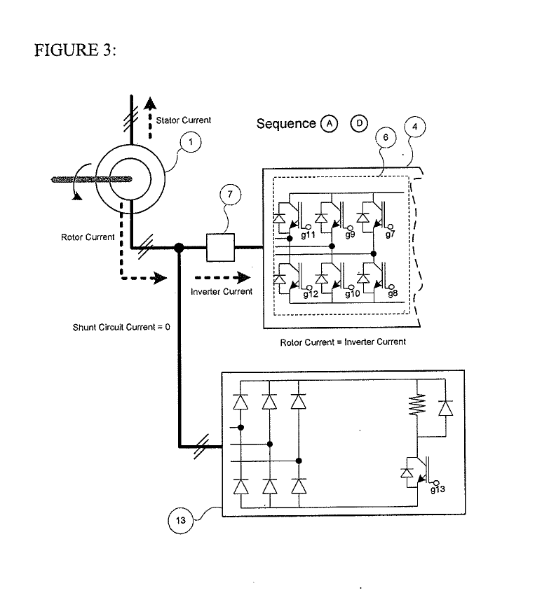

In conditions of normal operation, as shown in FIG. 3, the generator rotor current is the same current that flows through the inverter as the shunt protection circuit will not be connected and therefore, no current flows through it.

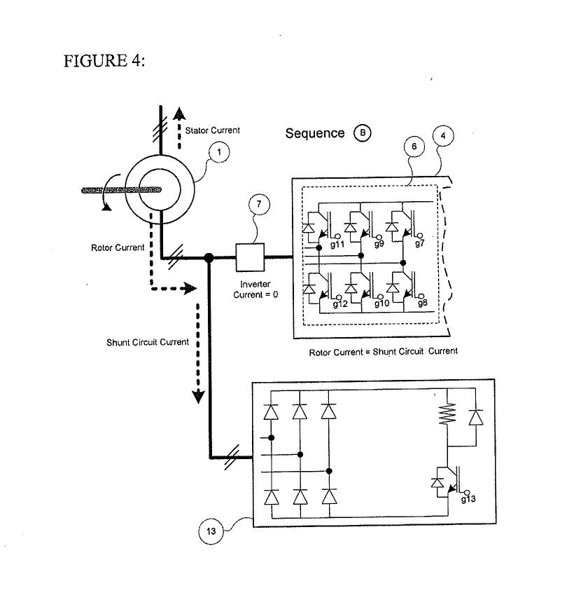

When the central control unit 10 identifies an abnormal operation by detecting an abnormal variation that is out of the operating range of any of the measured variables, the shunt protection circuit 13 is connected by activating the switches installed in this circuit using switching command 14 and at the same time cancelling the switching commands 12 of the inverter switches. The connection of the shunt protection circuit 13 and the disconnection of the inverter 6 are, therefore, synchronous. A voltage gap in the grid to which the generator 1 is connected is an example of abnormal operation, in which the switching commands 12, 14 will be governed as described. In this situation, when the inverter 6 is disconnected and the shunt protection circuit 13 is connected, the asynchronous wound rotor generator functions as an asynchronous squirrel cage machine in which the rotor currents, as shown in FIG. 4, are closed by the resistor circuit imposed by the shunt protection circuit 13. Thus the electrical disturbance that appears in the generator 1 due to the grid voltage gap will be absorbed by the shunt protection circuit 13 which, due to its resistive nature, will in turn dampen the disturbance.

The shunt protection circuit 13 must be duly dimensioned in order to be able to absorb the electrical disturbances that may appear in the generator 1 to which it is connected. These disturbances may be especially strong when they start, and may mean that large-amplitude currents are circulating through the elements that compose the protection circuit 13. The protection shunt circuits 13 prevent the converter 4 from being affected by the generator 1 disturbances, which allows the current peaks that may appear to circulate through circuits expressly designed for this sort of load, instead of circulating these currents through the converter 4.

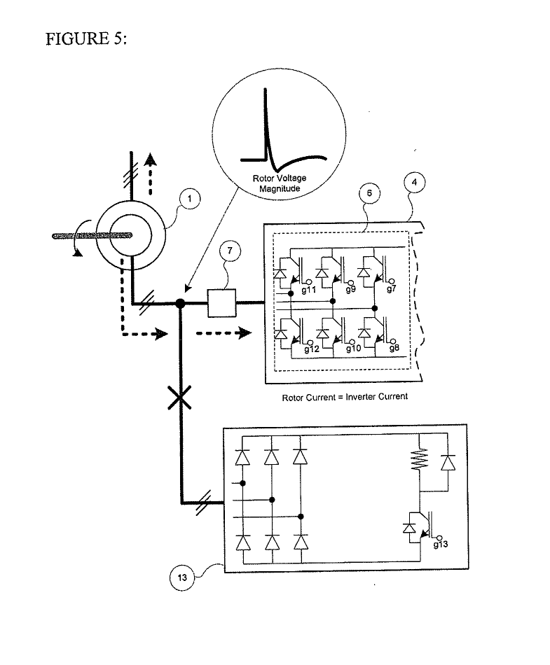

Once the generator disturbance has been damped, the shunt protection circuit 13 can be disconnected and the inverter 6 can be activated again, to control the current of the generator 1 once again. Activation of the shunt protection circuit 13 disconnection command can be determined depending on the operating range of the variables measured by the central control unit 10 or it could also be determined according to a fixed delay. The shunt protection circuit 13 will always be disconnected by deactivating the switching commands 14 of the switches installed in the resistor branches 16 that compose it, which interrupts the path along which the generator 1 current is circulating. Due to the inductive nature of the generator 1, a sudden failure of the current through the rotor would lead to an overvoltage in its windings (see peak of rotor voltage magnitude in FIG. 5). To avoid this effect, the off command for the shunt protection circuit 13 switches must be accompanied, at least, by the simultaneous activation of the switching commands 12 of the inverter switches to be able to activate a path for the rotor currents to circulate, so they do not suffer rough variations. This operating method, while valid in theory, is obstructed by the existence of the filter 7 connecting the inverter 6 to the generator 1 that acts as a stopper, i.e., “cork effect”, which prevents that current from being established and therefore potentially leading to the emergence of the aforementioned overvoltages in the generator rotor.

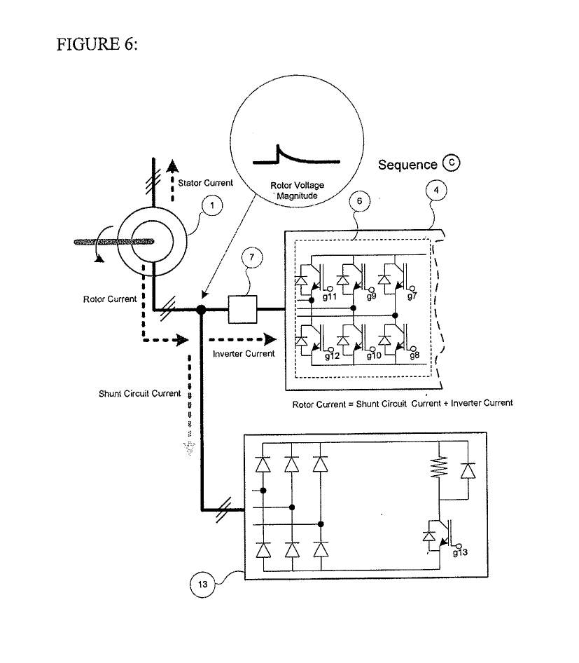

According to this embodiment, a procedure is described that prevents the aforementioned problems and guarantees the shunt protection circuit 13 current is cut out gently when disconnected. This procedure forces the activation of the inverter switching commands 12 prior to, i.e., moments before, deactivating the shunt protection circuit 13 switches. The inverter switching commands 12 will be activated in a specific way, activating the pulse width modulation of the inverter control so that a voltage with a small amplitude that is not zero is imposed in terminals of the inverter 6. The inverter 6, by means of the pulse width modulation of its associated control, will synthesize a small voltage between its phases so that the rotor current can find a path through the inverter 6, but avoids synthesizing a voltage with an amplitude equal to zero or which, in other words, will not create a short circuit between the inverter phases, to avoid significant current peaks through the switches. As shown in FIG. 6, this mechanism will permit some current to flow through the inverter 6 to progressively reduce the current that circulates through the shunt protection circuit 13. At this point the switches installed in the shunt protection circuit 13 will be deactivated, with the guarantee of minimizing the overvoltage that appears in the rotor windings of the generator (see rotor voltage magnitude in FIG. 6). Once the switches of the shunt protection circuit 13 have been deactivated, the inverter control will take control of the generator current once again by way of switching commands from the central control unit 10.

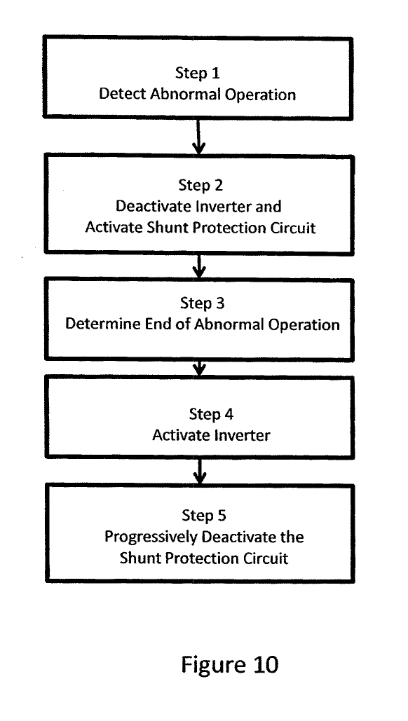

FIG. 10 shows a flowchart describing the method according to this embodiment. In step 1, an abnormal operation is detected from system variables measured by transducers. After detection of the abnormal operation, simultaneously, the inverter 6 is deactivated and the shunt protection circuit 13 is activated. After it is determined that the abnormal operation passed (step 3) the inverter 6 is activated in step 4. Following the activation of the inverter 6, the shunt protection circuit 13 is progressively deactivated in step 5 to transition from an activated state to a deactivated state.

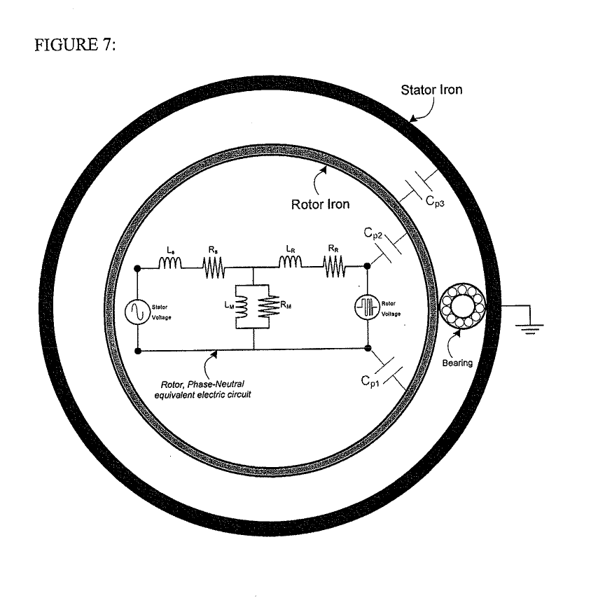

FIG. 7 shows a graphic representation of an electromagnetic structure of a doubly-fed synchronous generator. Specifically, FIG. 7 represents an equivalent electrical circuit per phase of the generator, including the stator and rotor resistors, and inductances. The power supply of the stator terminals represented in the circuit by means of a sinusoidal source representative of the electricity grid and the power supply of the rotor terminals by means of a switched voltage source representative of the inverter.

This figure also shows a representation of the iron housings of the rotor and stator, and the representation of the bearing that allows the rotor part (rotor) to be secured to the fixed part (stator), as well as a grounding connection of the stator housing. Also show in the figure is the parasitic capacitance between the electrical circuit of the generator and the rotor housing (Cp1 and Cp2), and the parasitic capacitance between the rotor housing and the stator housing (Cp3).

With reference to FIG. 7, the method described above avoids the emergence of overvoltages in the rotor windings that could otherwise reach significant amplitude values. These overvoltages, caused by the reaction of the inductances involved in the electrical circuits in the event of sudden current variations usually present wave forms similar to high frequency voltage peaks. In the event of such a voltage peak, the parasitic capacitances that exist in electrical circuits (FIG. 7) react with a low impedance due to the high frequency. Thus, in the event of voltage peaks of this nature, uncontrolled currents may circulate between the live phases of the generator and earth, through elements such as the bearings that could be damaged by the circulation of these currents.

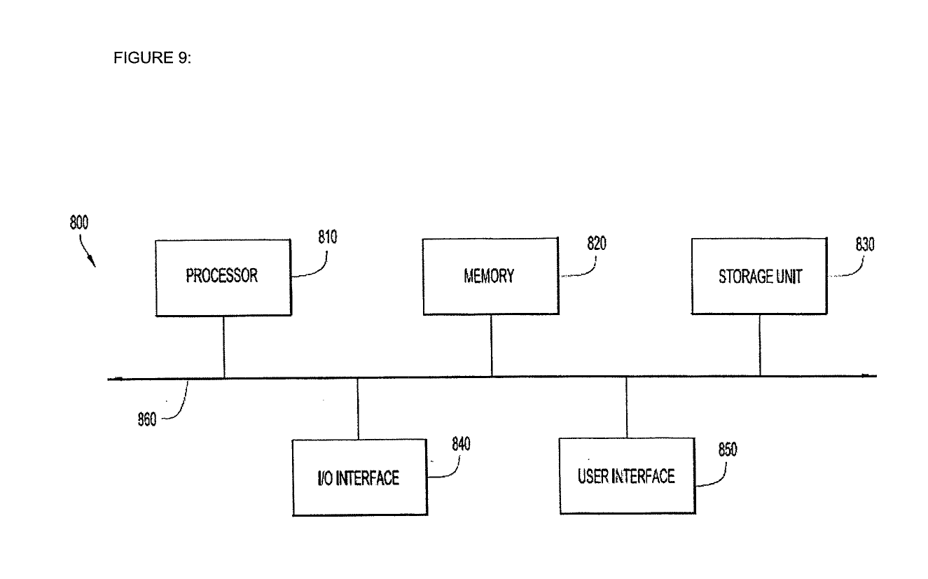

FIG. 9 is a diagram illustrating an embodiment of the central control unit 10 described above. Referring to FIG. 9, the system 800 may be a general purpose computer, special purpose computer, personal computer, server, or the like. The system 800 may include a processor 810, a memory 820, a storage unit 830, an I/O interface 840, a user interface 850, and a bus 860. The processor 810 may be a central processing unit (CPU), i.e. central control unit, that controls the operation of the system 800 by transmitting control signals and/or data over the bus 860 that communicably connects the elements 810 to 850 of the system 800 together. The bus 860 may be a control bus, a data bus, or the like. The processor 810 may be provided with instructions for implementing and controlling the operations of the system 800, for example, in the form of computer readable codes. The computer readable codes may be stored in the memory 820 or the storage unit 830. Alternatively, the computer readable codes may be received through the I/O interface 840 or the user interface 850. As discussed above, the memory 820 may include a RAM, a ROM, an EPROM, or Flash memory, or the like. As also discussed above, the storage unit 830 may include a hard disk drive (HDD), solid state drive, or the like. The storage unit 830 may store an operating system (OS) and application programs to be loaded into the memory 820 for execution by the processor 810. The I/O interface 840 performs data exchange between the system and other external devices, such as other systems or peripheral devices, directly or over a network, for example a LAN, WAN, or the Internet. The I/O interface 840 may include a universal serial bus (USB) port, a network interface card (NIC), Institution of Electronics and Electrical Engineers (IEEE) 1394 port, and the like. The user interface 850 receives input of a user and providing output to the user. The user interface 850 may include a mouse, keyboard, touchscreen, or other input device for receiving the user's input. The user interface 850 may also include a display, such as a monitor or liquid crystal display (LCD), speakers, and the like for providing output to the user.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A method for controlling a converter connected to an electrical machine comprising a shunt protection circuit installed between the electrical machine and an inverter, the method comprising:
detecting an abnormal operation of the electrical machine or a system connected to the electrical machine;
deactivating the inverter and activating the shunt protection circuit simultaneously in response to the detected abnormal operation;
activating the inverter in response to a second condition occurring after the abnormal operation; and
deactivating the shunt protection circuit after activating the inverter.

2. The method according to claim 1, wherein the abnormal operation is detected using transducers and the abnormal operation is determined to occur if the value of measurements from the transducers is outside of a predetermined operating range.

3. The method according to claim 1, wherein the second condition is deemed to occur when a predetermined period of time passes following the abnormal operation.

4. The method according to claim 2, wherein the second condition is deemed to occur when value of the measurements fall within predetermined safe operating range.

5. The method according to claim 1, wherein the switching frequency of the static switches of the inverter are maintained constant.

6. The method according to claim 1, wherein shunt protection circuit is deactivated by progressively reducing a current being received by the shunt protection circuit over a period of time to provide a smooth transition between an activated state of the shunt protection circuit and a deactivated state of the shunt protection circuit.

7. The method according to claim 1, further comprising:
during a normal operation, determining switching commands for the static switches of the inverter using a pulse width modulation mechanism to control the current through the electrical machine.

8. The method according to claim 7, wherein activating the inverter comprises activating switching commands of the static switches of the inverter, and
wherein deactivating the shunt protection circuit comprises deactivating switches in the shunt protection circuit using pulse width modulation mechanisms configured to impose a low-voltage setpoint greater than zero between inverter phases to permit a current to be activated so that current can flow through a rotor of the electrical machine in a manner that progressively reduces current flowing to the shunt protection circuit to prevent overvoltages in the rotor of the electrical machine.

9. An electrical generating apparatus, the apparatus comprising:
an electrical generator configured to be connected to an electrical grid;
a converter comprising an inverter connected to a rotor of the electrical generator;
a shunt protection circuit connected to the inverter and the rotor of the electrical generator; and
a control unit configured to activate and deactivate the inverter and the shunt protection circuit,
wherein the control unit is configured to, in response to determining that an abnormal condition is occurring in the electrical generator or an electrical grid to which the electrical generator is connected, deactivate the inverter and activate the shunt protection circuit,
wherein after it is determined that the abnormal condition has passed, the control unit is configured to activate the inverter before deactivating the shunt protection circuit.

10. The apparatus according to claim 9, further comprising transducers to detect voltage or current variations in the electrical generator or in the electrical grid, wherein the abnormal operation is determined to occur if the value of measurements from the transducers is outside of a predetermined operating range.

11. The apparatus according to claim 9, wherein the abnormal condition is deemed to have passed when a predetermined period of time passes after responding to the abnormal operation.

12. The apparatus according to claim 10, wherein the abnormal operation is deemed to have passed when value of the measurements fall within a predetermined safe operating range.

13. The apparatus according to claim 9, wherein shunt protection circuit is deactivated by progressively reducing a current being received by the shunt protection circuit over a period of time to provide a smooth transition between an activated state of the shunt protection circuit and a deactivated state of the shunt protection circuit.
